(19) United States
(12) Patent Application Publication
(10) Pub. No.: US 2005/0055263 A1
(43) Pub. Date: Mar. 10, 2005

(54) Method of providing internet-based expert diagnosis and analysis to consumer inquiries

(76) Inventor: Aditya K Pabuwal, Somerset, NJ (US)

Correspondence Address: Aditya K Pabuwal, 15 Smithwold Road, Somerset, NJ, 08873, US

(21) Appl. No.: 10/605,079

(22) Filed: Sep. 8, 2003

(51) Int. Cl. G06F 17/60

(52) U.S. Cl. 705/9

(57) ABSTRACT

This invention discloses a method of providing expert diagnosis and analysis to consumer inquiries via the internet. This method optimizes the consumer and expert interaction by profiling the consumer in advance of the initial expert interaction through a dynamic question and answer session and by optimizing the tools used by the expert to respond to consumer inquiries.

### BACKGROUND OF INVENTION

The present invention relates to techniques for providing internet-based expert diagnosis and analysis to consumer inquiries. Still more particularly, the present invention relates to methods for accurately defining the consumer inquiry and situation before expert intervention and for experts to efficiently respond to the consumer inquiry.

As consumers become more comfortable with the internet for personal interaction, they are increasingly turning to online sources for expert advice and help. Current internet-based consumer oriented advice websites do not properly profile the consumer in advance of the initial expert interaction, resulting in an unnecessary loss of time and money. The expert may either charge the consumer for the time needed to understand the consumer issue and situation or bear the cost on their own. In cases where an expert is forced to filter out certain “undesirable” consumers due to legal or professional reasons, the expert generally bears the cost and time of this effort. Additionally, internet-based advice websites generally do not provide experts a facility to optimally respond to consumer inquiries resulting in unnecessary time spent by the expert. Again, either the consumer or the expert bear the cost of this inefficiency.

U.S. Pat. No. 6,223,165 (2001), U.S. Pat. No. 6,549,889 (2003), U.S. Pat. No. 6,523,010 (2003) all to Lauffer and U.S. Pat. No. 6,513,013 (2003) to Stephanou disclose methods for connecting consumers to experts; however, these methods neither profile the consumer in advance of the initial interaction with the expert nor provide experts a facility to efficiently respond to consumer inquiries.

### SUMMARY OF INVENTION

The present invention allows the consumer to define their inquiry and situation in advance of the initial expert interaction and provides the expert a streamlined response facility to efficiently respond to consumer inquiries. The consumer defines their inquiry and situation through a series of questions and answers presented by the system. Each question presented by the system is based on the previous answer provided by the consumer. The system filters out certain consumers the expert can not serve due to legal or professional reasons. The expert response facility contains information provided by the consumer, a repository of subject matter knowledge used by the expert to help construct responses and a response area with pre-filled greetings, headers and footers. This approach efficiently uses expert time by providing the expert with a qualified consumer, a clearly defined consumer inquiry and situation and a streamlined response process.

### BRIEF DESCRIPTION OF DRAWINGS

FIG. 1 illustrates the process of the present invention.

FIG. 2 illustrates the consumer information collection dialog,

FIG. 3 illustrates the facility for expert response.

### DETAILED DESCRIPTION

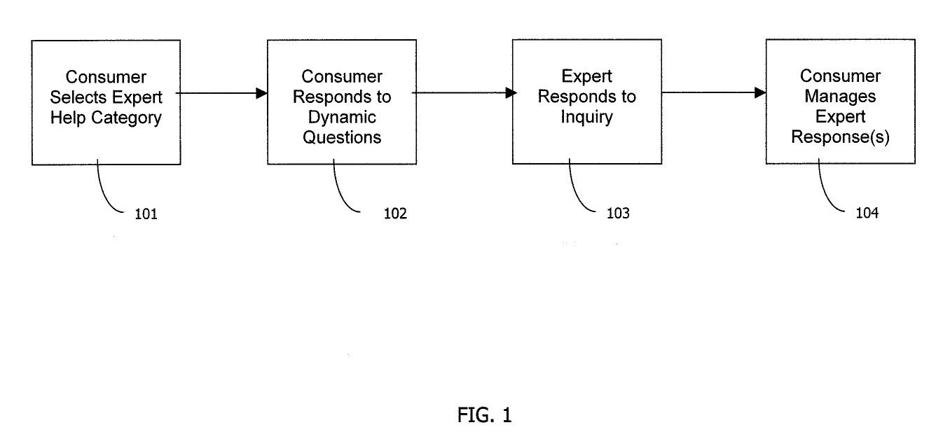

Referring to FIG. 1, the process begins when a consumer selects an expert help category 101. The consumer then responds to a series of dynamic questions presented by the system. Once the consumer exhausts the possible questions, the system has defined the consumer inquiry and has obtained the necessary personal information 102. The information is then conveyed to the expert. The expert reviews the information and responds to the consumer inquiry 103. The response is then conveyed to the consumer where they view the response and either request clarification or rate the response 104.

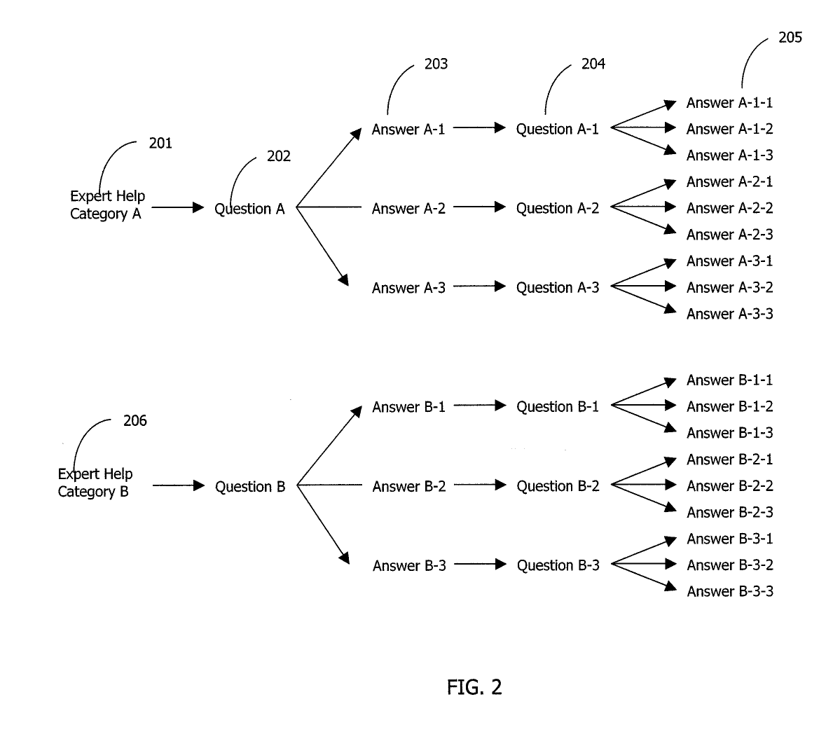

FIG. 2 presents a detailed view of the process defined by 102. The consumer selects an expert help category 201 which generates an initial question 202. The answer to the initial question 203 then generates the next question 204. The answer 205 to this question then generates the next question and so on until the consumer reaches the end of the question branch. At this point the consumer has defined their inquiry and personal information.

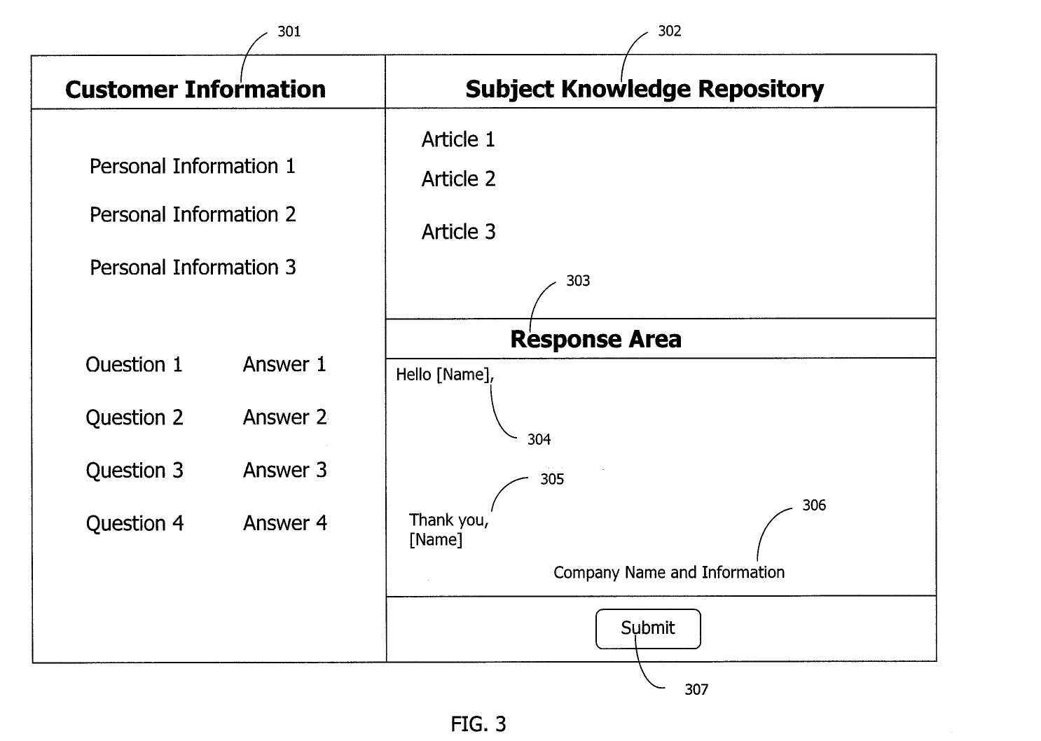

FIG. 3 presents a detailed view of the expert response facility used in the process defined in 103. The expert response facility is used by the expert to review the consumer inquiry and personal information 301 provided in FIG. 2 to respond to the consumer inquiry. The expert modifies an article from the subject knowledge repository 302, and completes the response in the response area 303. The system personalizes the response area with a greeting 304, signature 305 and footer 306 without need for expert intervention. Once complete, the expert conveys the response to the consumer by selecting the “Submit” button 307.

1. A method of providing internet-based expert diagnosis and analysis to consumer inquiries comprising a plurality of expert help categories, an information collection dialog presented to the consumer, a facility for experts to respond to consumer inquiries and a facility for consumers to manager expert responses.

2. The method as described in claim 1, wherein the information collection dialog is a series of questions and answers presented by the system to the consumer before said consumer first interacts with an expert.

3. The method as described in claim 2, wherein the first question within the series of questions is based on the expert help category selected by the consumer and subsequent questions are based on the consumer answer to the prior question.

4. The method as described in claim 3, wherein the series of questions and answers gather specific consumer information.

5. The method as described in claim 4, wherein the specific consumer information results in a defined consumer inquiry.

6. The method as described in claim 1, wherein the facility for experts to respond to consumer inquiries comprises the information provided by said consumer, a subject knowledge repository and a response area.

7. The method as described in claim 6, wherein the subject knowledge repository contains material for use in an expert response to the consumer.

8. The method as described in claim 6, wherein the response area comprises greetings, footers and signatures created by the system.

9. The method as described in claim 1, wherein the facility for consumers to manage expert responses comprises a summary listing of all expert responses, a detailed information on each response, a method for replying to expert responses and a method to rate expert responses.
